(19) United States
(12) Patent Application Publication
(10) Pub. No.: US 2015/0242840 A1
(43) Pub. Date: Aug. 27, 2015

(54) SYSTEMS AND METHODS FOR DYNAMIC BIOMETRIC CONFIGURATION COMPLIANCE CONTROL

(71) Applicant: JPMorgan Chase Bank, N.A., New York, NY (US)

(72) Inventor: Eren KURSUN, New York, NY (US)

(73) Assignee: JPMorgan Chase Bank, N.A., New York, NY (US)

(21) Appl. No.: 14/189,608

(22) Filed: Feb. 25, 2014

(51) Int. Cl. G06Q 20/32; G06Q 20/40

(52) U.S. Cl. CPC G06Q 20/3224; G06Q 20/4016; G06Q 20/40145

(57) ABSTRACT

Systems and methods for dynamically-configured compliance control are disclosed. According to one embodiment, a method may include (1) receiving, from an electronic device, a transaction request for a user that requires authentication; (2) at least one computer processor determining a target security level for the transaction; (3) the at least one computer processor determining a location of the electronic device; (4) the at least one computer processor determining at least one restriction on conducting the transaction based on the location of the electronic device; (5) the at least one computer processor determining at least one authentication configuration that meets the target security level and the at least one restriction on conducting the transaction; and (6) the at least one computer processor receiving user data in accordance with the authentication configuration.

### BACKGROUND OF THE INVENTION

1. Field of the Invention

The present invention generally relates to compliance control, more particularly, to systems and methods for dynamically-configured compliance control.

2. Description of the Related Art

In conducting mobile transactions, different laws and regulations may impact a user's ability to conduct a transaction. For example, the banking laws in one country may differ greatly from those in another country.

### SUMMARY OF THE INVENTION

Systems and methods for dynamically-configured compliance control are disclosed.

Methods for dynamically-configured compliance control are disclosed. According to one embodiment, the method may include (1) receiving, from an electronic device, a transaction request for a user that requires authentication; (2) at least one computer processor determining a target security level for the transaction; (3) the at least one computer processor determining a location of the electronic device; (4) the at least one computer processor determining at least one restriction on conducting the transaction based on the location of the electronic device; (5) the at least one computer processor determining at least one authentication configuration that meets the target security level and the at least one restriction on conducting the transaction; and (6) the at least one computer processor receiving user data in accordance with the authentication configuration.

In one embodiment, the method may further include the at least one computer processor determining at least one risk factor based on historical transaction data for at least one of the user and a type for the transaction.

In another embodiment, the method may further include the at least one computer processor performing statistical analysis on the transaction.

In another embodiment, the method may further include the at least one computer processor analyzing at least one of the transaction and the user for an anomaly.

In one embodiment, the restriction may be on a manner of user authentication.

In another embodiment, the restriction may be at least one legal requirement on a manner in which the transaction is conducted, and may include at least first level legal requirement and a second level legal requirement. The at least one computer processor may determine a hierarchy associated with first level legal requirement and the second level legal requirement and may select the restriction based on the determination.

In one embodiment, the method may further include the at least one computer processor determining at least one policy restriction on conducting the transaction. The at least one computer processor may determine the at least one authentication configuration to meet the target security level, the at least one restriction on conducting the transaction, and the policy restriction.

In one embodiment, the authentication configuration may be determined based on a number of available authentication modalities.

In another embodiment, the authentication configuration may be determined based on at least one electronic device specification.

In one embodiment, the electronic device specification may identify a characteristic for an available input on the electronic device.

In one embodiment, the method may further include completing the transaction with the authentication configuration.

In one embodiment, the authentication configuration may include at least one biometric.

Systems for dynamic compliance control are disclosed. In one embodiment, a system may include a user electronic device and a back-end. The user electronic may include at least one computer processor that receives a transaction request from a user and a compliance interface executed by the at least one computer processor. The back-end may include at least one interface for receiving the transaction request from the compliance interface; a restriction matrix that stores at least one transaction restriction; and at least one back-end computer processor that performs the following: determine a target security level for the transaction; determine at least one restriction on conducting the transaction based on the location of the electronic device; determine at least one authentication configuration that meets the target security level and the at least one restriction on conducting the transaction; and receive user data in accordance with the authentication configuration.

In one embodiment, the at least one back-end computer processor may also determine at least one risk factor based on historical transaction data for at least one of the user and a type for the transaction.

In one embodiment, the back-end may further include a statistical analysis engine that performs statistical analysis on the transaction.

In one embodiment, the back-end may further include an anomaly engine that analyzes at least one of the transaction and the user for an anomaly.

In one embodiment, the restriction may be on a manner of user authentication.

In another embodiment, the restriction may be at least one legal requirement on a manner in which the transaction is conducted, and the legal requirement may include at least first level legal requirement and a second level legal requirement.

In one embodiment, the back-end processor may further determine a hierarchy associated with first level legal requirement and the second level legal requirement and may select the restriction based on the determination.

In one embodiment, the back-end processor may further determine at least one policy restriction on conducting the transaction and determine the at least one authentication configuration to meet the target security level, the at least one restriction on conducting the transaction, and the policy restriction.

In one embodiment, the authentication configuration may be determined based on a number of available authentication modalities.

In one embodiment, the authentication configuration may be based on at least one electronic device specification.

In one embodiment, the electronic device specification may identify a characteristic for an available input on the electronic device.

In one embodiment, the authentication configuration may include at least one biometric.

In one embodiment, the user electronic device may further include a cache version of the restriction matrix.

Methods for using a compliance controller to dynamically select at least one modality are disclosed. In one embodiment, the method may include hierarchically refining the accepted modalities and specifications to identify a compliant solution. In another embodiment, the method may consider modality combination, authentication duration, the specifications in the authentication/transaction process (e.g., acquiring, communicating and storing data, authentication specs), etc.

In one embodiment, specialized constraints and guidelines for integrated biometric modalities (where different markers are tied spatiotemporally) are disclosed. Such guidelines may specify how such markers are created, specifications, numbers, etc.

In one embodiment, the method may involve negotiation in cases where not all rules, regulations, etc. are not met.

In one embodiment, restrictions/regulations may be communicated to the user using, for example, a terms/conditions statement.

In one embodiment, the resulting solution may be executed in coordination with the mobile device side, the server side, or any side by itself, by customizing the modalities, algorithms, thresholds, data acquisition duration, etc.

In one embodiment, the user's location information may be acquired from, for example, the global positioning system, other location identifier systems for finer grain location information (e.g., a building, a floor, etc.) signal broadcasts (e.g., building code broadcasts, etc.), from the user's own input, etc. The method may further retrieve or acquire applicable rules/restrictions/regulations/laws based on the location information.

An end-point controller apparatus (or finite state machine) for biometric configuration selection (can be implemented in hardware or software) is disclosed. In one embodiment, a compliance controller may be implemented as an embedded controller. The compliance controller may coordinate the modality availability and specification determination based on the user's profile data, the user's current location (e.g., from the global positioning system), device requirements, etc.

In one embodiment, a server-side controller (which may be implemented in hardware and/or software) may codifies the rules, regulations, laws, transaction requirements, security restrictions, policies, etc. using a look-up table. In one embodiment, natural language processing may be used to codify the rules, regulations, laws, etc. In another embodiment, they may be manually coded. In still another embodiment, a combination of automated and manual coding may be used.

In one embodiment, a method for manual approval process if the solution space is restricted and there are problems is disclosed. A compliance representative/management/or other party may be contacted in a manner similar to the way that a customer service representative may be contacted to resolve the conflict.

In one embodiment, the server-side controller may store the resulting information to the corresponding look up table/storage.

In one embodiment, the server-side controller may maintain and update requirements over time. For example, the server-side controller may update any entries with relevant changes.

In one embodiment, the server-side controller may access the look up table, content stored in the look up table, and run-time incoming data.

In one embodiment, the server-side controller may determine the combination of modalities and specifications of each (or integrated modality) based on the restrictions in the look-up table.

In one embodiment, the determination of modalities and specifications may be made through iterative refinement of the solution space over the hierarchy. In one embodiment, the determination may be made by reducing the solution space to overlapping requirements among the layers in the hierarchy or hierarchies. In another embodiment, the determination may be made by refining a solution by converging (or integrating) constraints (user, device, security, etc.).

In one embodiment, a cache structure to store historical patterns and solution spaces is disclosed. The cache structure may be applicable until there are changes in location, preferences, rules, regulations or any other parameter. The cache structure may provide temporary storage/cache for faster solution identification.

In one embodiment, a regulation matrix or look-up table is provided. The regulation matrix/look up table may include a hierarchical organization of coded regulations, laws, restrictions, user preferences, device configuration and constraints. This matrix/table may be organized at a corporate or organizational rules at variety of levels such as department, company-level, local and federal regulations, local/state/federal/or higher, municipality, building or other level.

In one embodiment, the rules, laws, regulations, etc. may be based on the user's country/state of origin, the country/state that the user is located in, etc.

In one embodiment, the matrix/table may include integrated biometrics specifications and options, device and environmental condition restrictions, transaction constraints (e.g., banking, mobile, etc.), etc. The table may further provide modality specifications and options for the rules, laws, restrictions, etc.

The matrix/table may also identify modality alternatives (such as alternative algorithms, security levels, etc.).

In one embodiment, the matrix/table may identify security requirements the laws, rules, regulations, profiles, modalities, etc.

The matrix/table may store user profile information, preferences and restrictions (e.g., the user cannot use certain modalities due to a disability, etc.).

In one embodiment, the matrix/table may identify restrictions for offline authentication (where there is no connectivity to the server for location information to identify the rules/regulations that apply).

In one embodiment, the matrix/table may identify any rules/restrictions for travel (e.g., intercontinental travel or other boundary conditions).

In one embodiment, a cached version of the matrix/look-up table may be provided on a mobile or other end device. The cached version may be coordinated with the server side matrix/table. In one embodiment, the cached version may be customized to the device specifics (e.g., camera, microphone, other sensors, whether it can be performed to execute highly critical transactions like trading, etc.).

In one embodiment, a compliance controller that regulates transactions and other processes is disclosed.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of a system for dynamically-configured compliance control according to one embodiment;

FIG. 2 is a flowchart depicting a method for dynamically-configured compliance control according on one embodiment;

FIG. 3 is a flowchart depicting a method for dynamically-configured compliance control according on one embodiment;

FIG. 4 is an exemplary configurations requirement table according to one embodiment;

FIG. 5 depicts a configuration for a system for compliance control according to one embodiment; and

FIG. 6 is a flowchart depicting a method for dynamically-configured compliance control according on one embodiment.

### DETAILED DESCRIPTION OF PREFERRED EMBODIMENTS

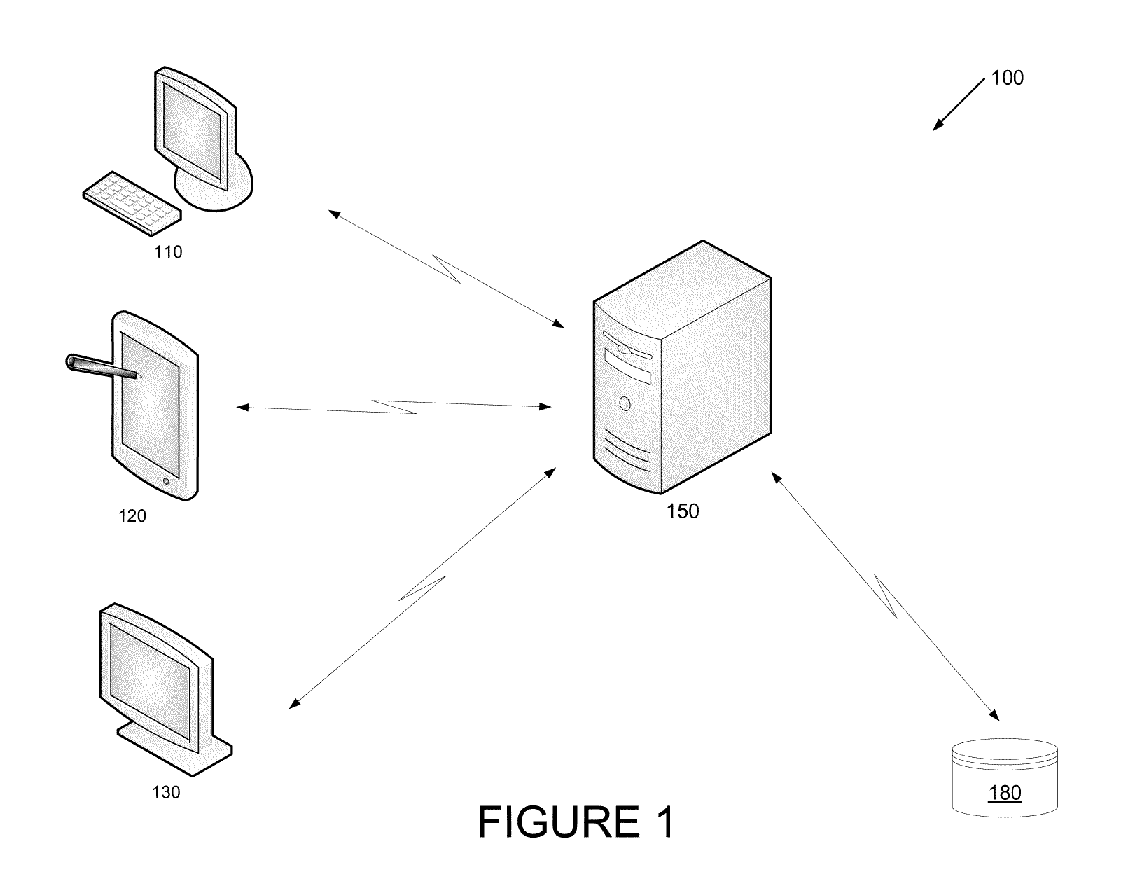

Several embodiments of the present invention and their advantages may be understood by referring to FIGS. 1-6, wherein like reference numerals refer to like elements.

In one embodiment, systems and methods for dynamically-configured compliance control are disclosed. For example, in the course of a transaction (e.g., authentication, purchase, financial transaction, etc.), application may check to determine the type of authentication, approval, etc. that is required to be in compliance with laws, regulations, policies, etc. For example, the application may consider laws of the country, state, or other region in which the user is present, resides, or is otherwise associated with; company policies; a user profile; the device; and any other suitable consideration to make sure that the user complies with these laws, regulations, and policies. Upon retrieving and reviewing these laws, policies, regulations, and other considerations, the application may select the appropriate modalities (biometric or otherwise), any constraints on their use (e.g., length of voice recordings, local storage, etc.), etc. If biometrics are not available to be used, the application may identify alternative authentication or access methods.

For example, when a user initiates biometric authentication, the application may retrieve the user's current location (e.g., a GPS location, user-supplied location, etc.) and translate that location into a country, state, city, etc. The application may then retrieve the applicable laws and regulations for that location, and may iteratively determine the safest use of biometrics. Thus, if a country permits the use of multi-modality biometrics, the state does not permit any biometrics to be stored locally, the application would harmonize these two requirements.

Next, the application may identify the applicable organizational policies that apply to the use of biometrics. The application may further consider the security level associated with the authentication sought by the user.

The application may refer to a matrix of modalities, regulations/policies, and other restrictions on the use of biometrics (e.g., security requirements) in order to select an appropriate combination of modalities, passwords, etc. to comply with the laws, regulations, and policies.

The application may have applicability beyond biometric authentication, such as in determining whether to permit access to applications to individuals.

While embodiments may involve the use of biometrics, the disclosure is not so limited. Other embodiments, such as alternative authentication processes, mobile banking applications, other broader enterprise/mobile applications whose use may governed/regulated by a number of laws and regulations, etc. are within the scope of this disclosure. For example, in one embodiment, a mobile banking application governed by a range of rules and regulations (varying across company, department regulations, state/federal law, etc.) is within the scope of this disclosure.

In one embodiment, the controller may be used for biometric authentication applying specific rules and regulations that may govern the use of biometric authentication.

Referring to FIG. 1, a block diagram of a system for dynamically-configured compliance control according to one embodiment is provided. System 100 includes workstation 110, which may be any suitable computer, including for example, desktop computers, laptop computers, notebook computers, etc.

System 100 may further include mobile electronic device 120. In one embodiment, mobile electronic device 120 may be a smartphone (e.g., Apple iPhone, Samsung Galaxy, etc.), a tablet computer (e.g., Apple iPad, Samsung Galaxy, Amazon Kindle, Barnes & Nobel Nook Tablet, etc.), Google Glass, Smart E-watch/Bracelet, a wearable electronic device, a personal electronic device, etc. In one embodiment, mobile electronic device 120 may include at least one camera for capturing a machine readable code (e.g., a bar code, QR code, etc.), a microphone, and a speaker. In one embodiment, mobile device 120 may include a front-facing camera and a rear-facing camera. Mobile device 120 may also include a range of sensors and data acquisition devices (such as voice acquisition devices/microphones, infrared cameras, motion sensors, global position systems, other sensors that may acquire electrical or chemical data, etc.). Although mobile device 120 may be depicted as a single device, it may be comprised of multiple electronic devices, sensors, etc.

In one embodiment, system 100 may include screen 130 that may be part of an access control system for a secure area. Screen 130 may be part of an access control system that may be provided at the exterior of a secure area.

System 100 may include server 150. In one embodiment, server 150 may host an application that may be used to authenticate a user. Although only one server is depicted in FIG. 1, more than one server may be provided. For example, a server for biometric authentication may be provided, a server for facial recognition may be provided, etc.

Database 180 may receive, store and/or maintain user information, account information, biometric information, etc.

Workstation 110, mobile electronic device 120 and screen 130 may communicate with server 150 over any suitable network, including the Internet, a local area network, wide area network, virtual private network, etc. In one embodiment, workstation 110 and mobile electronic device 120 and/or screen 130 may communicate with each other using any suitable communication protocol, including WiFi, Bluetooth, Near Field Communication, etc.

In one embodiment, server 150 may include a finite state machine or other controller (not shown) that may serve as the compliance engine that may identify applicable rules, laws, regulations, policies, restrictions, etc. on the use of modalities, biometrics, etc. In addition, database 180 may store a matrix of look-up table of rules, regulations, policies, security requirements, user profiles, etc. Any or all of workstation 110, mobile electronic device 120 and screen 130 may store or access a cached version of this table/matrix.

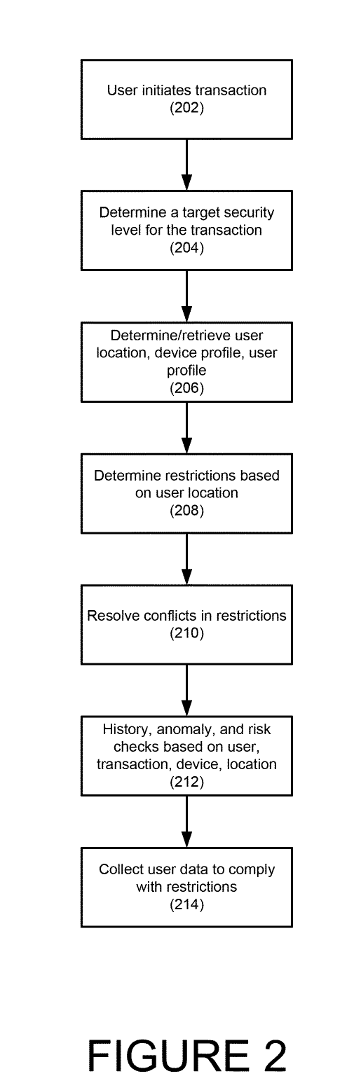

Referring to FIG. 2, a method for dynamic compliance control according to one embodiment is disclosed.

In step 202, a user may initiate a transaction using, for example, a mobile device (e.g., smartphone, tablet computer, etc.), a computer (e.g., notebook, laptop, desktop, workstation, etc.), a terminal, a kiosk, a transaction station (e.g., a point of sale device), etc. In one embodiment, the user may provide details for the requested transaction (e.g., transfer $X in funds from account Y to account Z). In another embodiment, the details for the transaction may be provided to the electronic device.

In step 204, a target security level for the transaction may be determined. In one embodiment, the target security level may be based on, for example, one or more of a transaction amount, a transaction location, a type of transaction, the parties involved to the transaction, any confidentiality issues, etc. Any other criteria may be used to determine the target security level as necessary and/or desired.

In step 206, information about the user and/or the user's device may be determined or retrieved. In one embodiment, the user's location may be determined based on the GPS location of the user's electronic device, a known location of a device (e.g., a kiosk location), a location that is manually entered by the user, a location based on a WiFi network, a location based on cellular triangulation, etc.

In step 208, any restrictions that may be applicable to the transaction may be identified. The restrictions may, for example, restrict the way in which a transaction may be conducted using the electronic device, restrict the way and/or manner in which a user may be authenticated, etc. In one embodiment, the restrictions may be based on the user location, and may include local, state, and federal regulations and/or laws (or their equivalents). In another embodiment, the restrictions may also be based on organizational/company policies. In still another embodiment, the restrictions may be based on an area in which the user is located (e.g., within a building, room, etc.). In still another embodiment, the restrictions may be based on the user. In yet another embodiment, the restrictions may be based on the specifications for the user's electronic device. Any combination of the above bases, as well as any other bases, may be considered as necessary and/or desired.

In one embodiment, the restrictions may be arranged hierarchically.

In one embodiment, the restrictions may relate to the collection and/or use of biometric data from the user; the type of biometric data that may be collected, used, transmitted, stored, etc.; the minimum device requirements for collecting that biometric data (e.g., camera resolution, sensors, etc.); the type of transactions that may be conducted; the locations, times, etc. at which the transaction may be (or may not be) conducted; the parties with which a transaction may or may not be conducted (e.g., blacklists, whitelists, prohibited nations, etc.), environmental restrictions (e.g., minimum lighting, maximum noise level, etc.), modalities that may be used; a minimum number of modalities or other factors that must be used together (e.g., multiple modalities, multiple factors, etc.), etc. Any restrictions may be considered as necessary and/or desired.

In step 210, any conflicts in the restrictions may be resolved. For example, the restrictions may be evaluated in order to determine how the transaction may be conducted and/or how the transaction may not be conducted. In one embodiment, the restrictions may be evaluated iteratively using the hierarchy of bases for the restrictions.

In one embodiment, if the conflicts cannot be resolved, the user may be requested to change the transaction, an exception may be requested, or the transaction may be denied. For example, if the user is requesting to transfer $2,000 but the limit is $1,000, the user may be asked to change the transaction amount so that the transaction may proceed. Alternatively, the user may request an exception, and the exception request may be evaluated automatically, by a person, etc.

In step 212, the transaction may be evaluated based on, for example, a transaction history for the user or device, anomalies, high risk, etc. In one embodiment, anything suspicious (e.g., first time the user requested this type of transaction; the transaction is an outlier in amount, type, parties, etc.; the transaction is a high risk transaction (e.g., high amount, risky parties, etc.) may result in warnings, the transaction being flagged for manual review, termination, additional authentication, etc.

In step 214, if the transaction is not suspicious, the user data may be collected to comply with the restrictions. In one embodiment, the user may further be required to agree to terms and/or conditions before the data may be collected.

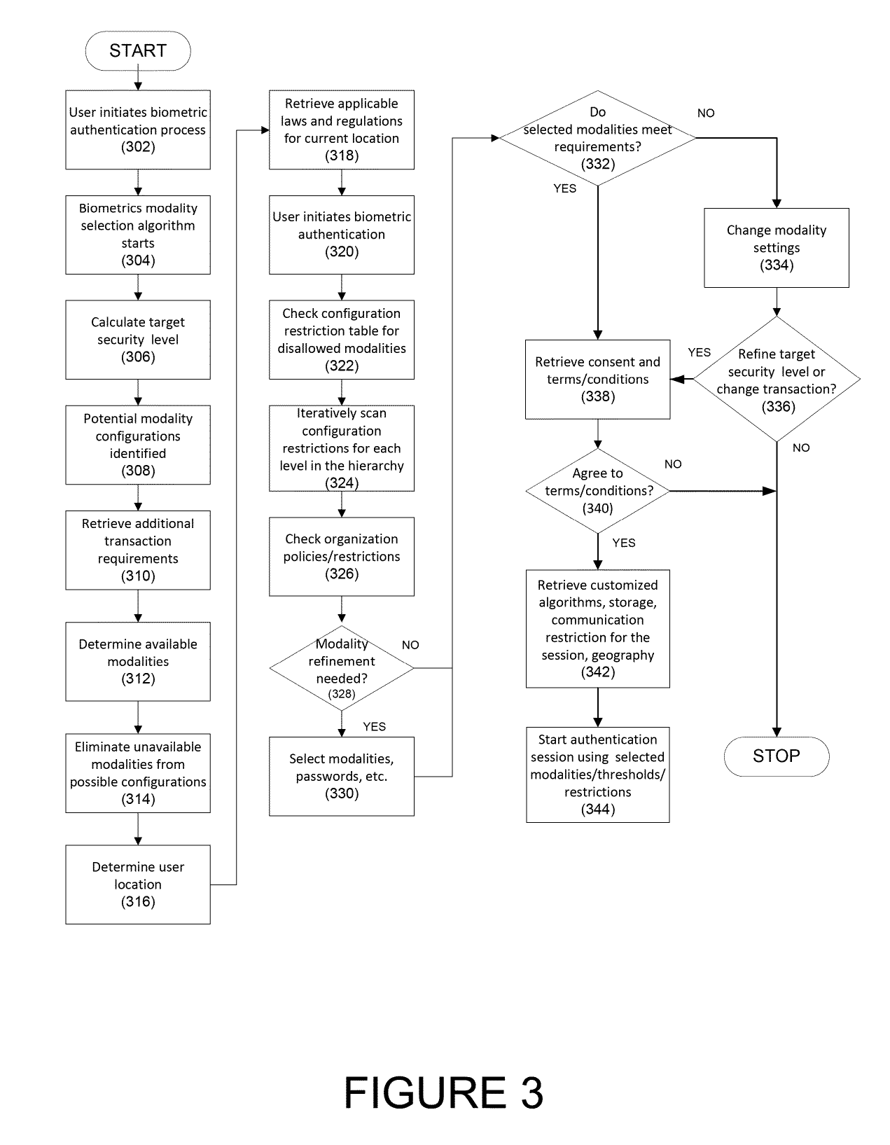

Referring to FIG. 3, a method for dynamic biometric configuration compliance control is disclosed according to one embodiment.

In step 302, a user may initiate the biometric authentication process. In one embodiment, this may involve initiating the process on a mobile device, such as a smartphone, tablet computer, laptop/notebook computer, wearable electronic device, etc.

In step 304, a biometric modality selection application executed on the electronic device may be initiated. In one embodiment, the application may run locally. In another embodiment, the application may execute on a server. In another embodiment, the application may execute on one or more mobile devices, servers, combinations thereof, etc.

In step 306, a target security level may be calculated for a specific transaction. In one embodiment, the target security level may be a function of laws and regulations, organizational regulations or policies, specifics of the transaction, and any other requirements. For example, a trading activity transaction with a value above a certain amount may require the highest security level, whereas an authentication session to access a corporate phone directory may require a much lower security level.

In step 308, potential modality configurations to meet the target security level may be determined. For example, if a security level requires two mode authentication, then the available modes (e.g., voice, image, gesture, etc.) may be identified.

In step 310, any additional transaction requirements may be identified. For example, the transaction may require the entry of a password, a PIN, other security information, out of band, multi-factor authentication, etc. In one embodiment, the additional transaction requirements may be retrieved from a database. As discussed above, databases, tables, etc. may be accessed to guide the process.

In step 312, specifications and data characteristics for the electronic device, such as input devices available, camera resolution, noise level, lighting level, etc.) may be retrieved in order to determine available modalities. In one embodiment, the specifications/characteristics may be retrieved from a database. In another embodiment, the specifications/characteristics may be retrieved from the device itself.

In step 314, unavailable modalities may be eliminated from the possible modality configurations. In one embodiment, a table of regulations and/or a user profile table may be accessed to determine which modalities should be eliminated.

In step 316, the location of the user's electronic device may be determined. In one embodiment, the location may be determined from a GPS location provided by the electronic device. Other methods for determining location, such as cellular triangulation, WiFi network location, manual user location entry, etc. may be used as necessary and/or desired. In one embodiment, a finer grain control may be executed. For example, if the user is located within a building where cameras or other image devices are not allowed (e.g., a government facility, a military facility, etc.) the controller may disable the features and corresponding authentication capabilities based on the building regulations. As another example, if the user is trying to use the voice recognition in an area where noise levels are restricted, the corresponding voice recognition capability may be restricted.

In step 318, the laws and/or regulations (on interpretation of the laws/regulations) concerning the use of biometrics that apply to the location may be retrieved. In one embodiment, the interpretation may be based on federal, state, local, etc. laws/regulations. In one embodiment, the laws/regulations and/or interpretation thereon may be retrieved from a database. the interpretation may indicate whether a certain modality may be used, any restriction on the collection of the modality (e.g., length of sample collected, area of the body that may be imaged, collection of background data, etc.), any restriction of the storage and/or transmission of the biometric data, etc. Any suitable way of communicating any restrictions on the use of biometrics may be used as necessary and/or desired.

In one embodiment, the laws and regulations may be considered and reviewed separately.

In step 320, the user may initiate biometric authentication.

In step 322, a configuration restriction table may be accessed. In one embodiment, a hierarchical configuration of relevant rules, regulations, policies and restrictions may be retrieved. A hierarchy of laws/regulations, for example, may include a county/municipality law, state law, federal law, etc. For example, a district in Switzerland may have a specific restriction, a regional law may indicate another set of requirements, etc. A corresponding restriction table may be maintained in the system. This configuration restriction table may be scanned for the entire hierarchy.

In step 324, the configuration restrictions may be scanned for each level within a hierarchy. For example, starting with level i (e.g., the lowest level, such as a county or municipality), then moving to level i+1 (e.g., state level), then moving to level i+2 (e.g., federal level), the restrictions may be scanned, analyzed, and/or reviewed.

In step 326, company/organization (e.g., company-wide, line of business level, division, department, project, etc.) restrictions may be scanned. In one embodiments, these may be done at a single level (e.g., company level), on a plurality of levels (e.g., division level and company level, etc.). In a similar fashion companies have associated hierarchies with specific rules, restrictions and regulations. In one embodiment, this hierarchy may be maintained independent of the local/state/federal hierarchy. In another embodiment, this hierarchy may be maintained as a level (or levels) in the local/state/federal hierarchy.

For example, in one embodiment, a department rule/policy may indicate that no employee from that department can use a specific modality, that a security specification must meet a certain criteria, etc. An example is an investment department having stricter security standards than a marketing department. As another example, an organization may have different security levels for different geographical locations, whether the user is outside his or her home area, etc. Each level in the hierarchy may be scanned, processed (with rules/regulations/restrictions being factored in), and overlapping subsets may be calculated.

In step 328, a check may made to see if refinement is needed between independent hierarchies. If it is, in step 330, modalities, passwords, etc. may be selected.

In step 332, a check is made to see if the selected modalities meet the requirements of the hierarchies. If they do not, in step 334, the modality settings may be changed. For example, thresholds, duration of authentication, steps, etc. may be changed to meet the security requirements. The selected modalities may then be checked again. In one embodiment, the process may be repeated for a number of iterations. If, after a number of iterations, the selected modalities do not meet the requirements, in step 336, the target security level and/or transaction specifics may be changed or negotiated. If, following a change, the requirements are met, the process may continue to step 338. If it does not, the process may terminate.

In step 338, terms/conditions may be presented to the user. If, in step 340, the user agrees to the terms/conditions, in step 342, the customized algorithms, storage restrictions, communication restrictions, etc. for the session, geography, etc. may be retrieved.

In step 344, the authentication session, including the collection of biometrics, is initiated.

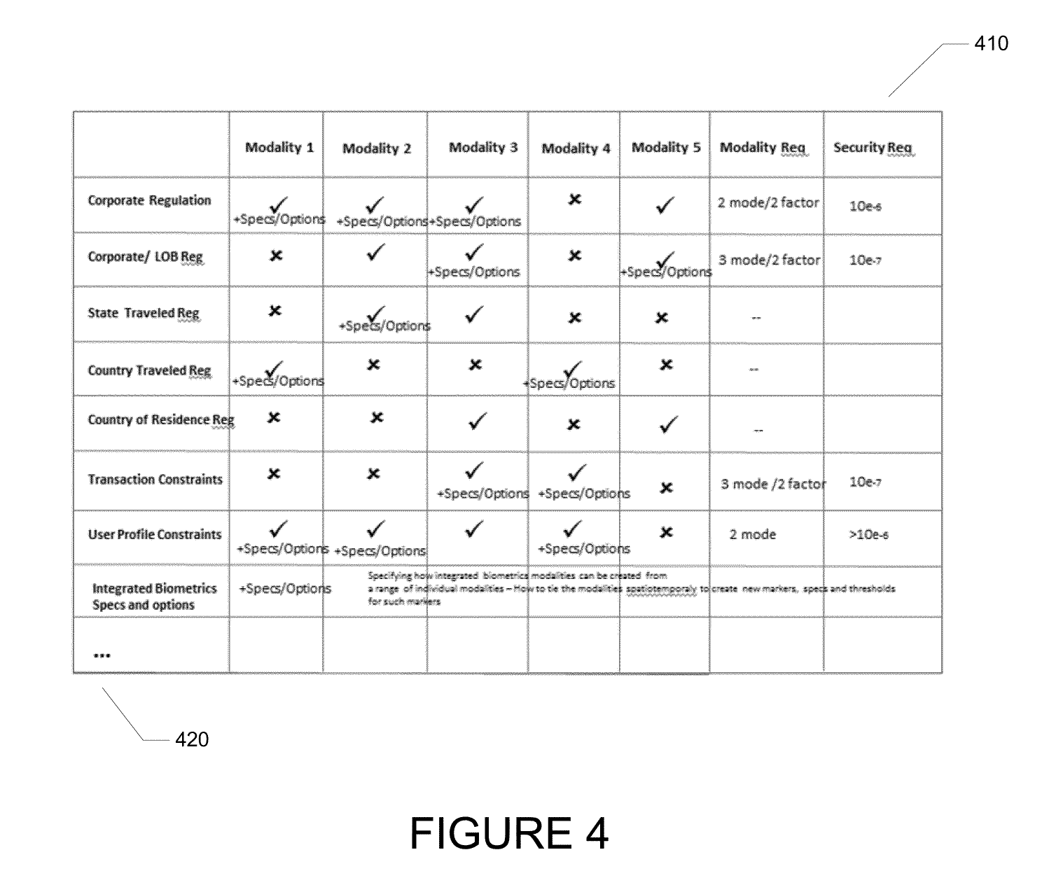

Referring to FIG. 4, an example of a restriction table is provided according to one embodiment. In one embodiment, table 400 may be stored in, for example, a back-end system, as a local version (e.g., a cached version) on the electronic device, etc. Table 400 may provide storage for the high level guidelines for the process. The controller may use the data provided in table 400 as well as other databases, tables, etc. The depiction of restriction table 400 is exemplary only; and suitable table, database, etc. may be used as necessary and/or desired.

In the exemplary embodiment, table 400 may include a plurality of columns and rows. In one embodiment, columns 410 may represent different modalities that may be used. Examples may include password authentication, voice authentication, biometric authentication, etc. In one embodiment, a column may provide a modality requirement for each level of the hierarchy (e.g., 2 mode/2 factor authentication), and another column may identify the security requirement/confidence factor (e.g., 10e-6) for that level of the hierarchy. In one biometric authentication embodiment, a target EER (equal error rate) or FAR(false accept rate) may be required for an authentication session. The 10e-6 in this example could be one in a million false accept rate, for instance. The resulting modalities may then be selected based on the target EER or FAR rates or other rates. This can also be a password equivalence, e.g., equivalent to a 9 character password etc.

Rows 420 may represent a hierarchy of laws, rules, regulations, policies, user profiles, etc. that may be considered. For example, corporate regulations/policies, state regulations, country regulations, transaction specifics and limitations, user profile and constraints, etc. may be considered. In another embodiment, tables (not shown) may be provided that represent different hierarchies.

In another embodiment, rows 420 may also represent security specifications, other trade union or governing entity rules, regulations, building/site rules and regulations, device constraints and specifications, etc.

Although the information in table 400 is represented as a table using a row/column format, it should be recognized that this information may be represented in other ways. For example, this information may be presented as a graph, as multiple and interlinked matrices, etc.

In one embodiment, a compliance controller that may be used with, for example, financial transaction compliance is disclosed. Financial transaction compliance may include, for example, deposit account regulation, withdrawal limits and reserve requirements, privacy and customer protection, anti-money laundering, credit card practices, lending practices and limits, debt collection, etc., to name a few. In the United States, banking regulations are implemented at both the state and federal level. In other countries, centralized regulatory entities regulate financial transactions.

As an example, a transaction in direct relation to anti-money laundering regulations may be automatically blocked on the requesting device through an application. The content of the transaction may be scanned with respect to a compliance matrix. If the content matches for the “restricted country,” the transaction will be blocked and an error message may be provided to the user with corresponding information.

In one embodiment, compliance guidelines from a range of governments, institutions, agencies, etc. may be codified. There may be three general aspects of this codification: (1) natural language processing of the guidelines to machine readable controller statements; (2) human input and checking (in editing and inputting regulations, rules, guidelines, etc.); and (3) example-based preprocessing (e.g., identifying matching transactions and regulation guidelines, decision making, etc. based on examples and experiences).

In one embodiment, the compliance controller, which may be an application for a mobile device, a computer program, etc. may execute in the background of each application that a system (e.g., mobile device, desktop, laptop, tablet computer, server, etc.) executes. The system may include a memory, finite state machines that input regulatory statements in codified form, etc.

In one embodiment, the regulations may be organized in a hierarchy. A suitable hierarchy may correspond to local, state and federal regulations, as well was any other areas involved. For example, if a transaction involves both the United States and the United Kingdom, regulations for both countries may be checked.

In one embodiment, the regulation checks may be performed in parallel with other hierarchies. First, for each transaction initiated by the user (end user or corporate user), the system may communicate the transaction specifications to the back-end cloud infrastructure. The storage and finite state machines may reside on both the cloud infrastructure and end-user device, such as mobile device. The codified matrix of restrictions may include: (a) local/federal regulations from all regulatory entities in all countries involved; (b) local/federal laws including all countries, states involved in the transaction; (c) corporate rules/policies hierarchy for the geography, department, function, job title, etc.; (d) security restrictions (e.g., independent measures that further restrict the types of transactions that can be executed); (e) other local rules/restrictions (e.g., specific restrictions regarding the exact location of the mobile device for instance); (f) any user preferences and/or restrictions.

Next, each hierarchy may be independently and iteratively refined to identify a solution space within the hierarchy. The restrictions of the independent hierarchies may be iteratively merged to find a solution space. The process may involve pruning restrictions from individual entities and terminating if any single entity is not-satisfied.

In one embodiment the individual transaction may be checked against each entity in the matrix for compliance. In another embodiment, a solution space may be calculated for the specifications and details may be checked in the later stages.

In another embodiment, systems and method for non-deterministic compliance risk control are disclosed. As discussed above, the determination of full compliance may also include a search stage, where the transaction and its characteristics (e.g., the user executing the transaction, the location, state, country of the transaction, specifics of the transaction, transaction amounts, etc.) may be collected. This information may be cross-checked with stored historical data and in terms of its match to that data.

Prior non-compliance problems may be stored, for example, in “History Tables.” These history tables may be stored with the institution, which may be a financial institution, a healthcare institution, pharmaceutical providers, medical device manufacturers, insurance provides, etc. In one embodiment, the history table may reside in the back-end infrastructure and may be updated with each entry.

The matching scores with history tables may be used to give a non-deterministic conclusion that is separate from the deterministic conclusion from the compliance matrix. Anomaly detection and statistical analysis of the transaction may be performed in addition to the history table checks.

The end-user interface/mobile or workstation may include a memory, such as a cache memory. The back end may use the cache and higher level guidelines (that may be specific to the user) to collect and analyze data from a collection of users and back-logs information.

In one embodiment, in addition to a deterministic “compliant” “non-compliant” guideline, a compliance risk score may also be provided based on the compliance matrix (i.e., the matching level with the historical data table, the risk profile of the user, the risk profile of the transaction, anomaly detection algorithm output and statistical analysis results).

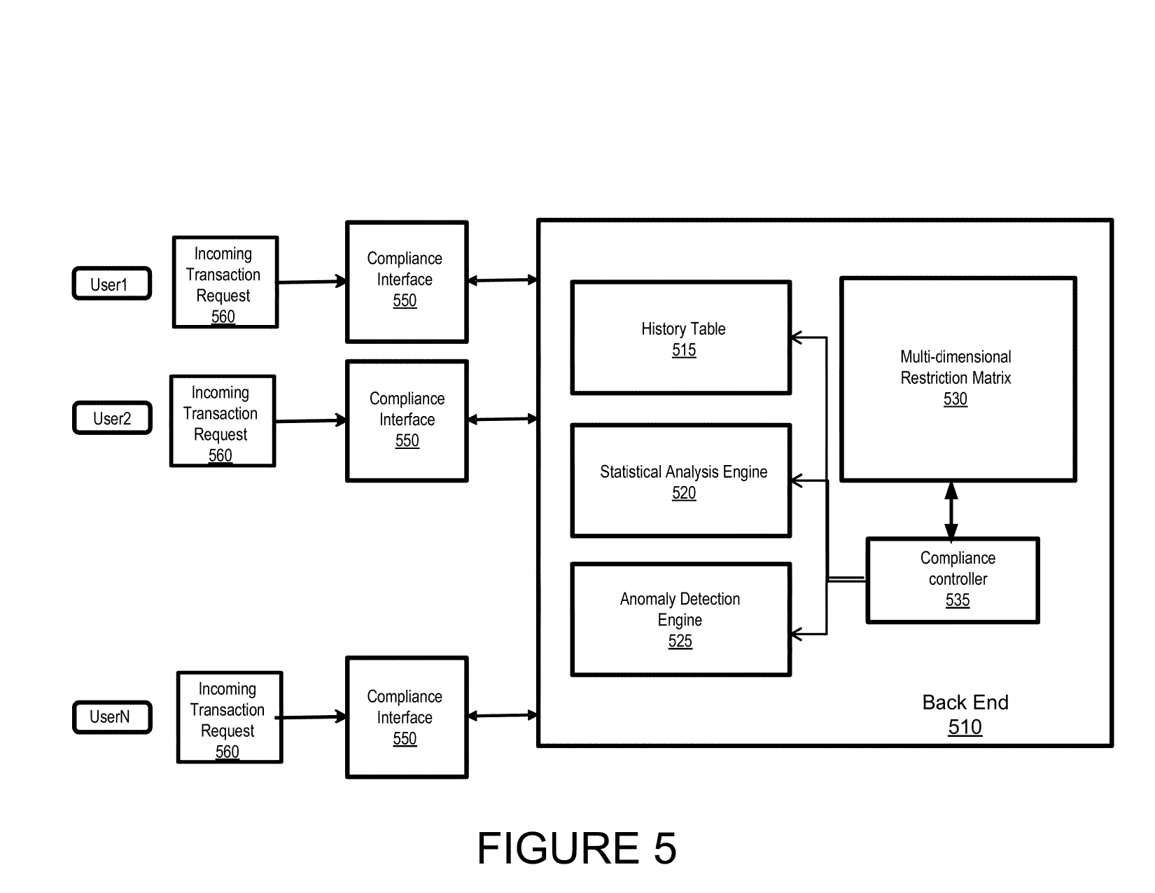

Referring to FIG. 5, a system for transaction compliance is disclosed according to one embodiment. System 500 may include back-end 510, which may be a server, a plurality of servers, etc.; compliance interfaces 550, a plurality of users (User1-UserN) and a plurality of incoming transaction requests 560.

In one embodiment, back-end 510 may include history table 515, statistical analysis engine 520, anomaly detection engine 525, multi-dimensional restriction matrix 530, and compliance controller 535. In one embodiment, history table 515 may store transaction data, user data, etc. and may be updated with each entry. In one embodiment, the history table may store data for more than user; for example, it may store data for multiple users so that similar transactions involving different users may be considered.

Statistical analysis engine 520 may calculate a risk based on the history, anomaly, etc. In one embodiment, statistical analysis engine 520 may give a range of acceptable (e.g., a likelihood that the transaction is proper) rather than a binary response for a proposed transaction.

Anomaly detection engine 525 may detect any outlying transactions or any other sort of anomaly based on, for example, the user profile and the outputs of history table 515, statistical analysis engine 520, etc. For example, if the transaction is something that the user may be authorized to conduct, but is of a type that had not been conducted before, the transaction may be flagged as an anomaly.

Multi-dimensional restriction matrix may 530 may include a matrix of restrictions that may be applicable to the user, transaction, device, etc.

Compliance controller 535 may communicate with history table 515, statistical analysis engine 520, anomaly detection engine 525, and/or multi-dimensional restriction matrix 530. In one embodiment, compliance controller 535 may be, for example, a finite state machine.

In one embodiment, any of User1-UserN may submit one or more incoming transaction request 560 to compliance interface 550. Compliance interface may be an application, computer program, etc. that is executed on a mobile electronic device, a desktop, notebook, laptop, tablet computer, a terminal, a kiosk, etc. Compliance interface 550 may include a memory, such as a cache memory. In one embodiment, compliance interface 550 may store, maintain, and/or receive a user profile, transaction information, etc.

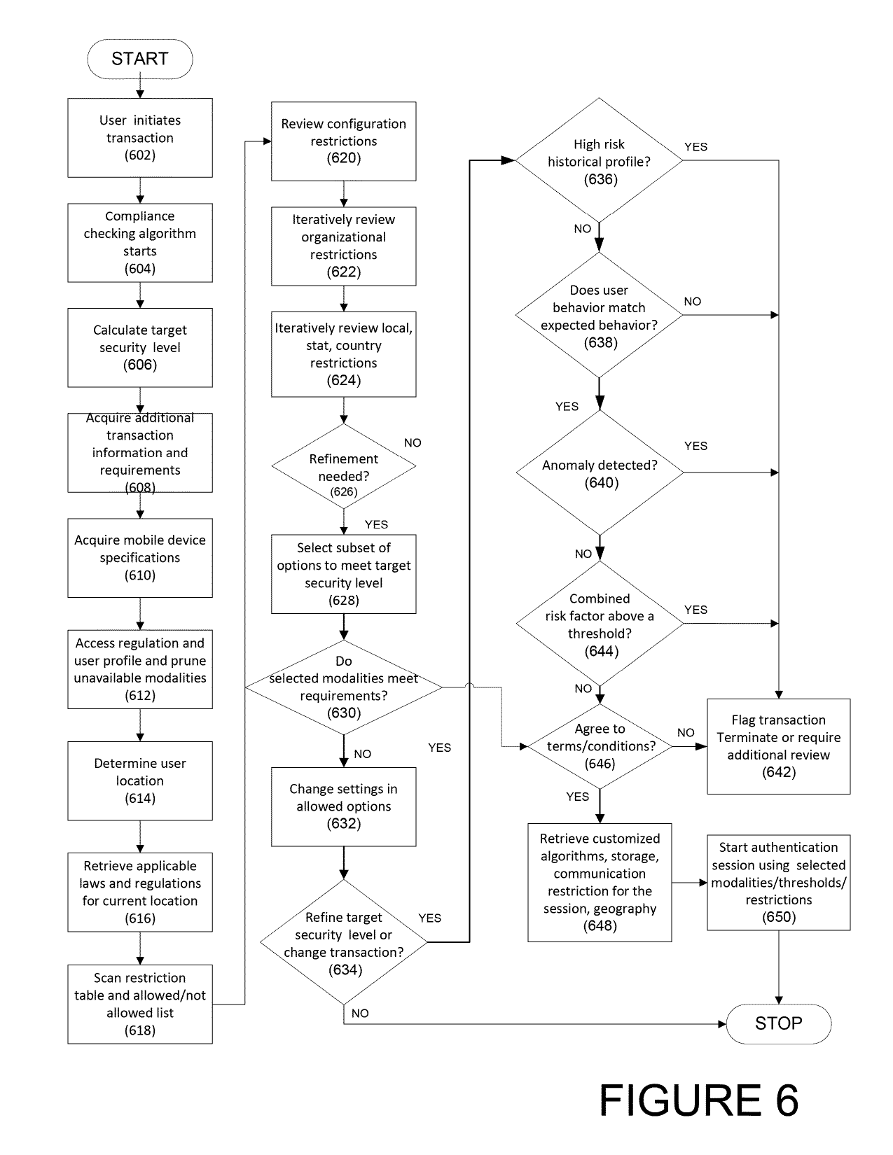

Referring to FIG. 6, a method for checking compliance is disclosed. In step 602, a user initiates a transaction using an electronic device such as a mobile electronic device (e.g., a smartphone), a computer (e.g., tablet, notebook, desktop, etc.), kiosk, terminal, etc. In one embodiment, the transaction may be initiated through an application or software application such as a compliance interface.

In step 604, the transaction request may be evaluated using, or example, a multi-dimensional compliance checking algorithm.

In step 606, a target security level for the transaction may be determined. In one embodiment, this may be a function of corporate/organization regulations, transaction specifics, and any other requirements as necessary and/or desired.

In step 608, any additional transaction information, requirements, etc. may be acquired.

In step 610, specifications for the electronic device on which the transaction request is received may be received. In one embodiment, this may include characteristics of the electronic device, data availability on the electronic device (e.g., whether data is stored on the device, the type of data that is stored (e.g., digital certificates, etc.), the type of data the electronic device can receive, etc.), etc.

In step 612, a regulation and user profile table may be accessed. In one embodiment, unavailable modalities (e.g., those that are not supported by the user's device) may be eliminated.

In step 614, the user's location may be acquired. In one embodiment, this may involve retrieving the GPS location of the user's electronic device. In one embodiment, the user's state, country, area, etc. locations may be determined from the location.

In another embodiment, the user's location may be determined based on the network to which it is connected, cellular triangulation, manual input, device detection mechanisms, etc. The location may be determined by a combination of these location determining techniques or any other location determining technique as necessary and/or desired.

In one embodiment, the location of the user may be identified at a building level, floor level, or even room level as necessary and/or desired.

In step 616, the applicable laws and regulations for the local, regional, country, etc. identified for the user location may be retrieved.

In step 618, the configuration restriction table may be reviewed, including the allowed/not allowed list of options for each hierarchy.

In step 620, the configuration restrictions may be reviewed.

In step 622, for each level in the hierarchy, the company, organization, group, line of business, etc. restrictions may be reviewed. In one embodiment, the current level and the next higher level may be reviewed. In one embodiment, if there is a range of options for each of the levels, the options maybe narrowed to a subset of overlapping options.

In one embodiment, the process may be repeated for each level in the hierarchy.

In step 624, for each level in the hierarchy, the state, country, region, etc. restrictions may be reviewed. In one embodiment, the current level and the next higher level may be reviewed. If there is a range of options, the options maybe narrowed to a subset of overlapping options.

In one embodiment, the process may be repeated for each level in the hierarchy.

In step 626, a decision may be made as to whether additional refinement of the options is needed. If it is, in step 628, a subset of options that may meet the target security level may be selected. For example, multiple hierarchies may have overlap in terms of specific constraints, levels, modalities, rules, etc. The solution may be refined by identifying any conflicting outcomes resulting from different outcomes; identifying and clearing ambiguities; and identifying a solution space that is consistent with the rules/constraints of all hierarchies applicable.

If additional refinement is not necessary, in step 630, a determination is made as to whether or not the selection meets requirements, or if there are conflicting requirements.

If the selection does not meet requirements, then in step 632, the allowed option setting may be changed to meet specifications. For example, thresholds, duration of authentication, steps, etc. may be changed to meet the security requirements. The selected options may then be checked again. In one embodiment, the process may be repeated for a number of iterations. If, after a number of iterations, the selected options do not meet the requirements, in step 634, the target security level and/or transaction specifics may be changed or negotiated. If, following a change, the requirements are met, the process may continue to step 636. If it does not, the process may terminate.

In step 636, the history table may be checked for high-risk historical profiles. In one embodiment the history table may be checked for past transactions conducted by the user, similar transactions by other users, transactions with the device, and any other matching dimensions. In one embodiment, risk factors may be embedded into each matching dimension as necessary and/or desired.

If the transaction is not a high risk historical profile, then the evaluation continues. If it is, in step 642, the user may be warned, the transaction may be flagged for manual review, termination, additional authentication, etc.

In step 638, a statistical analysis of the transaction, user, device, etc. may be performed to determine if the transaction is an expected behavior for the user. In one embodiment, if the transaction is an expected behavior, the process may continue. If it is not an expected behavior, in step 642, the user may be warned, the transaction may be flagged for manual review, termination, additional authentication, etc.

In step 640, the transaction may be checked for anomaly. In one embodiment, the anomaly detection may be a machine-learned anomaly detection process. In one embodiment, if an anomaly is not detected, the process may continue. If an anomaly is detected, in step 642, the user may be warned, the transaction may be flagged for manual review, termination, additional authentication, etc.

In step 644, a combined risk factor may be calculated based on the embedded risk factors (e.g., user, transaction type, etc.), anomaly detection, history, and statistical analysis. In one embodiment, each factor may be given an independent weighting. If the combined risk factor is below a certain threshold, the process may continue. If the combined risk factor is above a certain threshold, in step 642, the user may be warned, the transaction may be flagged for manual review, termination, additional authentication, etc.

In step 646, the user may be presented with terms/conditions, and if the user agrees, the process may continue to step 648, where customized algorithms, storage restrictions, communication restrictions, etc. for the session, geography, etc. may be retrieved.

In step 650, the authentication session, including the collection of biometrics, is initiated.

The disclosures of the following are hereby incorporated, by reference, in their entireties: U.S. patent applications Ser. Nos. 13/908,618, 13/940,097; 13/492,126; 13/297,475; 11/337563, 12/534,167; 10/867,103; 12/715,520; 10/710,315; 10/710,328; 11/294,785; U.S. Provisional Patent Application Ser. Nos. 61/820,917, 61/823,669 and 61/844,097; and U.S. Pat. Nos. 8,028,896 and 7,117,365.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for dynamically-configured compliance control, comprising:
receiving, from an electronic device, a transaction request for a user that requires authentication;
at least one computer processor determining a target security level for the transaction;
the at least one computer processor determining a location of the electronic device;
the at least one computer processor determining at least one restriction on conducting the transaction based on the location of the electronic device;
the at least one computer processor determining at least one authentication configuration that meets the target security level and the at least one restriction on conducting the transaction, the authentication configuration comprising at least one of an authentication modality and an electronic device configuration; and
the at least one computer processor receiving user data in accordance with the authentication configuration.

2. The method of claim 1, further comprising:
the at least one computer processor determining at least one risk factor based on historical transaction data for at least one of the user and a type for the transaction.

3. The method of claim 1, further comprising:
the at least one computer processor performing statistical analysis on the transaction.

4. The method of claim 1, further comprising:
the at least one computer processor analyzing at least one of the transaction and the user for an anomaly.

5. The method of claim 1, wherein the restriction is on a manner of user authentication.

6. The method of claim 1, wherein the restriction is at least one legal requirement on a manner in which the transaction is conducted.

7. The method of claim 6, wherein the at least one legal requirement is one of a law and a regulation.

8. The method of claim 6, wherein the at least one legal requirement comprises at least a first level legal requirement and a second level legal requirement.

9. The method of claim 8, further comprising:
the at least one computer processor determining a hierarchy associated with first level legal requirement and the second level legal requirement; and
the at least one computer processor selecting the restriction based on the determination.

10. The method of claim 1, further comprising:
the at least one computer processor determining at least one policy restriction on conducting the transaction; and
wherein the at least one computer processor determines the at least one authentication configuration to meet the target security level, the at least one restriction on conducting the transaction, and the policy restriction.

11. The method of claim 1, wherein the authentication modality is selected from a plurality of available authentication modalities.

12. The method of claim 1, wherein the electronic device configuration is based on at least one electronic device specification.

13. The method of claim 12, wherein the electronic device specification identifies a characteristic for an available input on the electronic device.

14. The method of claim 1, further comprising:
completing the transaction with the authentication configuration.

15. The method of claim 1, wherein the authentication configuration comprises at least one biometric.

16. The method of claim 1, wherein there are a plurality of hierarchies for a plurality of restrictions, and wherein the at least one computer determines at least one authentication configuration by one of merging the hierarchies and resolving conflicts in the hierarchies.

17. A system for dynamic compliance control, comprising:
a user electronic device comprising:
at least one computer processor that receives a transaction request from a user; and
a compliance interface executed by the at least one computer processor;
a back-end comprising:
at least one interface for receiving the transaction request from the compliance interface;
a restriction matrix that stores at least one transaction restriction; and
at least one back-end computer processor that performs the following:
determine a target security level for the transaction;
determine at least one restriction on conducting the transaction based on the location of the electronic device;
determine at least one authentication configuration that meets the target security level and the at least one restriction on conducting the transaction, the authentication configuration comprising at least one of an authentication modality and an electronic device configuration; and
receive user data in accordance with the authentication configuration.

18. The system of claim 17, wherein the at least one back-end computer processor further determines at least one risk factor based on historical transaction data for at least one of the user and a type for the transaction.

19. The system of claim 17, wherein the back-end further comprises a statistical analysis engine that performs statistical analysis on the transaction.

20. The system of claim 17, wherein the back-end further comprises an anomaly engine that analyzes at least one of the transaction and the user for an anomaly.

21. The system of claim 17, wherein the restriction is on a manner of user authentication.

22. The system of claim 17, wherein the restriction is at least one legal requirement on a manner in which the transaction is conducted.

23. The system of claim 22, wherein the at least one legal requirement comprises at least first level legal requirement and a second level legal requirement

24. The system of claim 22, wherein the back-end processor further:
determines a hierarchy associated with first level legal requirement and the second level legal requirement; and
selects the restriction based on the determination.

25. The system of claim 17, wherein the back-end processor further:
determines at least one policy restriction on conducting the transaction; and
determines the at least one authentication configuration to meet the target security level, the at least one restriction on conducting the transaction, and the policy restriction.

26. The system of claim 17, wherein the authentication modality is selected from a plurality of available authentication modalities.

27. The system of claim 17, wherein the electronic device configuration is based on at least one electronic device specification.

28. The system of claim 27, wherein the electronic device specification identifies a characteristic for an available input on the electronic device.

29. The system of claim 17, wherein the authentication configuration comprises at least one biometric.

30. The system of claim 17, wherein the user electronic device further comprises a cache version of the restriction matrix.
